(19) United States
(12) Patent Application Publication
(10) Pub. No.: US 2012/0303474 A1
(43) Pub. Date: Nov. 29, 2012

(54) VEHICLE TRADE BANKING SYSTEM

(76) Inventor: Nathan Sanel, Bow, NH (US)

(21) Appl. No.: 13/114,273

(22) Filed: May 24, 2011

(51) Int. Cl. G06Q 30/00

(52) U.S. Cl. 705/26.4

(57) ABSTRACT

A vehicle trade banking system for dealers and wholesalers that buy and sell automobiles, boats, motorcycles, and other vehicles that uses an application software system that accepts, distributes and stores vehicle data, price quotation data and vehicle condition data to facilitate the banking of vehicle trade-ins allowing dealers to confirm a buyer for a trade-in and thereby accept a trade-in from a consumer interested in purchasing a newer vehicle from the dealer.

### FIELD OF THE INVENTION

The present invention relates to a vehicle trade banking system for dealers and wholesalers that buy and sell automobiles, boats, motorcycles, and other vehicles. The system more specifically accepts, distributes and stores vehicle data, price quotation data and vehicle condition data to facilitate the banking of vehicle trade-ins allowing dealers to confirm a buyer for a trade-in in real-time and thereby accept a trade-in from a consumer interested in purchasing a newer vehicle from the dealer.

### BACKGROUND OF THE INVENTION

In the used vehicle retail and wholesale markets a number of vehicle price valuation tools, auction networks and vehicle title history search systems are known in the art. The known systems allow a user to enter specific vehicle criteria and request quotes and/or bid, i.e. send quotes, or purchase vehicles of interest using internet and networking computerized systems. Important to the new and used vehicle sales industry is the evaluation and acceptance of trade-ins at prices which permit the dealer to offer and assist a retail buyer with discounts in the purchase of newer or different vehicles, while ensuring that the dealer is able to sell, auction or otherwise turn over the trade-in vehicle without losing any money and possibly making a profit on the trade-in vehicle as it is sold to a wholesaler or similar industry buyer. Critical to dealers in accepting a trade-in vehicle is proper appraisal and pricing of that vehicle, to maximize profit in both the sale of the newer/different vehicle and in the re-sale of the trade-in.

Price quotations can be time sensitive particularly when the vehicle owner is on the dealer's premises to make a deal and purchase a new vehicle. Commonly, a dealer must, in the middle of negotiations with the vehicle owner, pick up a telephone to contact the two or three reliable wholesalers that they most often deal with to see if there is any interest in the trade-in vehicle. During the conversation, the dealer may describe the vehicle condition. The wholesaler will then either have the dealer wait while they research vehicle pricing using the online tools, review their current inventory and evaluate other factors such as “book” value, from conventional sources such as Kelley Blue Book® to determine a price, or say they will call back, and the dealer is left waiting, unable to continue as effectively in the current price negotiations with the consumer.

For many reasons the trade-in and new vehicle sales are not always immediately consummated, sometimes due to such time-dependent research and review of known pricing tools. Usually there is some negotiation time period between the dealer and the consumer until a relatively firm price is reached and during this time the dealer may potentially be waiting for at least one of his wholesalers to return a more definite quote, i.e. price, of what the wholesaler is willing to pay for the trade-in vehicle.

A period of time sometimes, one to two weeks or more may pass before the dealer again contacts the wholesaler and says the car is ready for presumably the price agreed to and the wholesaler may pick up the car, that is if each party has accurately recorded the price and condition that the parties agreed to. However, commonly one or the other party has not captured the price or vehicle information from the telephone conversation accurately or the condition of the vehicle was in someway misrepresented so now the parties must renegotiate a reasonable vehicle price, taking more time and risking a loss to one or the other party if the transaction was not what was agreed upon.

In U.S. Pat. No. 5,978,776 to Seretti et al. a vehicle data exchange system distributes vehicle information in real-time to users of the system in order to minimize or eliminate the use of wholesalers is described. A key feature of this exchange system is that pricing or appraisal information is obtained from other dealers within the network within a short period of time, that time period optimally being when the car purchaser offering a trade-in vehicle is waiting. The system operates by sending vehicle input data to a plurality of computer terminals within a network. The system then waits a period of 3 to 5 minutes for price quotation responses and if none are received, then by incorporating a repeater, the system re-transmits the data to the network of dealers. After this time period, the system waits for another time period of between 15 minutes to an hour and then by incorporating the repeater again re-transmits the data and waits for a response. The re-transmission of data to the inclusive network allows for users of the network that were busy and were not accessing the computer terminal at the appropriate time to receive the vehicle input data and respond with a price quotation if the vehicle is of interest.

After the 15 minutes to an hour the repeater does not re-transmit the date, because presumably a consumer would not remain on the dealer's premises for that long a period of time. This real-time approach using a repeater provides the dealer with a strong possibility that they will receive a price quotation from another dealer within the period of time that the consumer is available so that the dealer may negotiate the trade-in value into the new vehicle price, without the necessity of the dealer contacting a wholesaler for a trade-in price. What the Seretti et al. system does not do in particular is database this quote or vehicle information for later use.

The acceptance of a quotation for purchase of a vehicle from another dealer or wholesaler prior to or during the negotiation of a vehicle trade-in is known as “banking the trade”. A dealer may more readily accept a vehicle for trade even if it is not a vehicle normally sold by the dealer if they learn or know of an interested party who is willing to quote on and buy the vehicle and thereby “bank the trade” for the dealer, giving them some protection from loss on a vehicle that the dealer would not normally take in trade. The dealer trying to decide how to negotiate for the trade-in vehicle is now provided with a price that they may use in negotiating the trade-in with the consumer. The most current and up-to-date pricing or value of a trade-in vehicle is critical where vehicle pricing is based on vehicle condition, the geographic area and of course the make and model of the vehicle and other market conditions especially supply and demand. While a dealer may first review an online database such as Carfax®, NADA® or Kelly Blue Book®, this general pricing may be out of date or not match the condition of the offered vehicle.

What is needed is a trade banking system that is accessible by both dealers and wholesalers and that easily and accurately tracks price quotation data with the condition of the vehicle to clarify agreements and reduce negotiation time. The quote data tracking system would allow the dealer or seller to select the most profitable or acceptable quote from a number of offers and then only contact those wholesalers who have made a reasonable offer. The data tracking system with the condition of the vehicle would also assist the purchasing dealer or wholesaler where if a sales transaction is delayed and the vehicle is not traded-in immediately, both the dealer and the purchaser have a record of the price that was offered and of the condition of the vehicle. If the vehicle does not meet this condition, the offered price may be renegotiated because both parties have access to and may renegotiate from the same information. Accordingly, what is needed is a vehicle trade banking system that provides real-time price quotation information and also stores the offered quotations and vehicle condition data to assist both dealers and wholesalers in the acceptance and sale of vehicle trade-ins.

### OBJECT AND SUMMARY OF THE INVENTION

The present invention relates to a vehicle trade banking system that provides real-time quotation information using email or text notification and stores vehicle condition data, quotations and accepted pricing.

One object of the present invention is user access using an internet protocol and secure login and passwords.

Another object of the present invention is the storage of all user vehicle data, price quotations and contact information.

Another object of the present invention is the ability for a wholesaler or dealer to configure vehicle features and characteristics to receive alerts on sales of specific makes, years and models.

Another object of the present invention is the ability for a seller to set a priority with the quotation, such as urgent to denote to an interested buyer that the quote is time sensitive.

Another object of the present invention is to provide a status for each vehicle offered to denote for example a new quote, a quote is given, the vehicle is ready for pick up or the vehicle has been picked up.

Another object of the present invention is to generate a notification that a quote has been accepted and therefore further price quotation of the vehicle is closed.

A further object of the invention is to provide analysis and compiling of quotation data to provide an up to date vehicle value guide as a reference for future price quotations.

A still further object of the invention is to print, export or mine vehicle price quotation data for reporting and data analysis.

A still further object of the invention is to provide additional pricing through the vehicle trade banking system price quotation data from external value guides and databases such as NADA Guide or Kelley Blue Book® to provide additional information and even comparison data to produce accurate quote estimates in real time for any vehicle within the vehicle trade banking system.

The present invention is directed to a vehicle trade banking system comprising application software installed on a server having a database and connected to the internet, the application software comprising; a new vehicle entry member interface; a quote entry member interface; a vehicle quote management member interface; a quote history database having vehicle data and quote transaction information; a notification generator; and wherein the notification generator creates and transmits vehicle data and quote entry transaction information using the internet to a network of interested vehicle buyers and sellers.

The present invention is further directed to a method of banking a price for a trade-in vehicle, comprising the steps of accessing a vehicle trade banking application software system; entering vehicle information for a trade-in vehicle; generating an electronic message from the vehicle information and distributing that message to a network of interested buyers; receiving at least one electronic message of a price quotation from an interested buyer from the network of interested buyers; accepting the price quotation; and storing all information from the transaction on a database connected to a server that is connected to the internet.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a schematic diagram of computer system for a first embodiment of the vehicle trade banking system;

FIG. 2 is a diagrammatic view of a first embodiment of a vehicle trade banking system network;

FIG. 3 is an embodiment of a user interface for a login screen for a first embodiment of the vehicle trade banking system;

FIG. 4 is an embodiment of a user interface for a quote request screen for a first embodiment of the vehicle trade banking system;

FIG. 5 is an embodiment of a user interface for a vehicle specific quote page for a first embodiment of the vehicle trade banking system;

FIG. 6 is an embodiment of a user interface for a quote request details page for a first embodiment of the vehicle trade banking system;

FIG. 7 is an embodiment of a user interface for a quote request menu for a first embodiment of the vehicle trade banking system;

FIG. 8 is an embodiment of a user interface for a new quote request page for a new vehicle entry for a first embodiment of the vehicle trade banking system;

FIG. 9 is an embodiment of a user interface for a new quote request page for a new vehicle entry for a first embodiment of the vehicle trade banking system;

FIG. 10 is an embodiment of a user interface for a new vehicle quote request electronic message for a first embodiment of the vehicle trade banking system;

FIG. 11 is an embodiment of a user interface for a new vehicle details screen for a first embodiment of the vehicle trade banking system;

FIG. 12 is an embodiment of a user interface for a quote entry screen for a first embodiment of the vehicle trade banking system;

FIG. 13 is an embodiment of a user interface for a buyer/member's main menu for a first embodiment of the vehicle trade banking system;

FIG. 14 is an embodiment of a user interface for a new quote request electronic message for a first embodiment of the vehicle trade banking system;

FIG. 15 is an embodiment of a user interface for a quote acceptance screen for a first embodiment of the vehicle trade banking system;

FIG. 16 is an embodiment of a user interface for the quote acceptance electronic message for a first embodiment of the vehicle trade banking system;

FIG. 17 is an embodiment of a user interface for the quote management screen for a first embodiment of a vehicle trade banking system;

FIG. 18 is an embodiment of a user interface for a quote details screen for a vehicle trade banking system;

FIG. 19 is a flow diagram of one embodiment of a method of operation for a first embodiment of a vehicle trade banking system;

FIG. 20 is a flow diagram of one embodiment of a method of operation for a seller operating a first embodiment of a vehicle trade banking system;

FIG. 21 is a flow diagram of one embodiment of a method of operation for a buyer operating a first embodiment of a vehicle trade banking system;

FIG. 22 is one embodiment of an administration screen of a first embodiment of a vehicle trade banking system;

FIG. 23 is one embodiment of a member entry screen of a first embodiment of a vehicle trade banking system; and

FIG. 24 is one embodiment of an administration menu of a first embodiment of a vehicle trade banking system.

### DETAILED DESCRIPTION OF THE PREFERRED EMBODIMENTS

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Other aspects of such algorithms and apparatus, and hardware and/or software for producing and otherwise processing the data involved therewith, not specifically shown or described herein may be selected from such systems, algorithms, components, and elements known in the art.

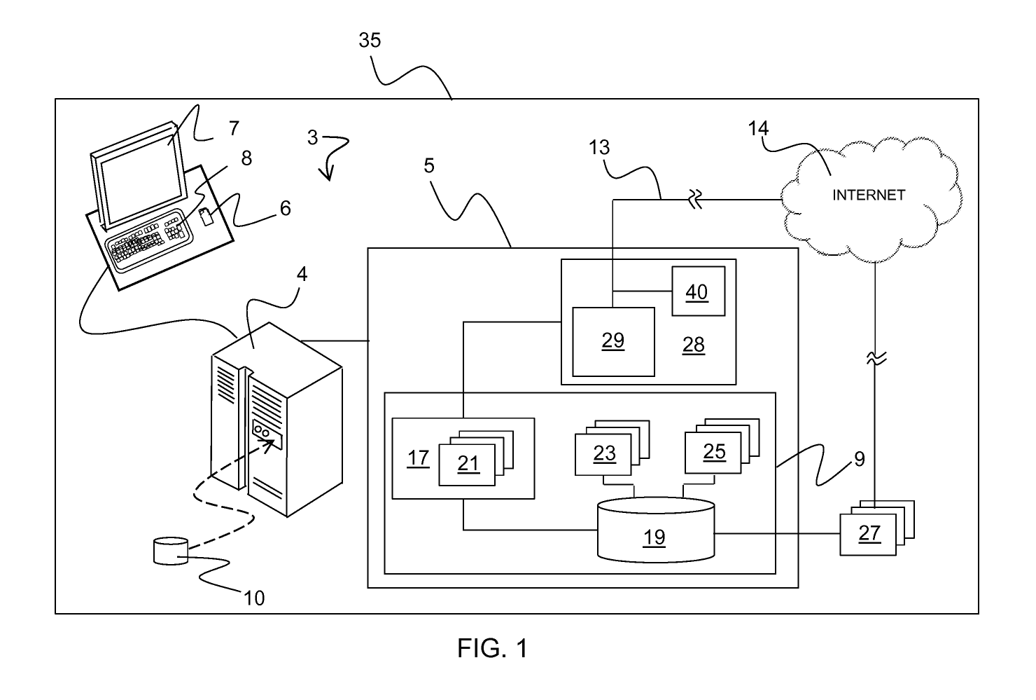

The present invention can be implemented in computer hardware and computerized equipment. For example, the method can be performed using a system including one or more digital communications devices and/or one or more personal computers. Referring to FIG. 1, there is illustrated a computer system 3 for implementing the present invention. Although the computer system 3 is shown for the purpose of illustrating a preferred embodiment, the present invention is not limited to the computer system 3 shown, but may be used with any electronic processing system such as found in digital communications devices, cellular phones and other mobile devices, home computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the microprocessor-based unit 5 for displaying user-related information associated with the software, e.g., by means of a graphical user interface. A keyboard 8 is also connected to the microprocessor-based unit 5 for permitting a user to input information to a software program. As an alternative to using the keyboard 8 for input, a mouse 6 may be used for moving a selector on the display 7 or alternatively a touch screen input device may be provided for selecting an item.

Memory, in any form, can be included and is illustrated as a hard-disk device such as computer readable storage medium 9 or compact disk-read only memory (CD-ROM) 10, which can include software programs, is inserted into the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the microprocessor-based unit 5 may be programmed, as is well known in the art, for storing the software program internally. A printer or other output device can also be connected to the microprocessor-based unit 5 for printing a hardcopy of the output from the computer system. The microprocessor-based unit 5 can have a network connection 13, such as a telephone line, network cable or wireless link, to an external network, such as a local area network or the Internet 14.

The output device 7 provides visually to the user transactional data that has been subject to transformations. The output device 7 can be a monitor or other visual computer screen or graphical user interface (GUI) a printer or other output device that provides a visual or other representation of a final output from the microprocessor-based unit 5. The output device 7 can also be an output device that provides the transactional data as a digital file.

The microprocessor-based unit 5 provides means for processing the transactional data to produce readily discernable, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 shown in FIG. 1 can store a computer program product having a program stored in the computer readable storage medium 9, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), read only memory (ROM) or flash memory data storage devices. The associated computer program can also be stored on any other physical device or medium employed to store a computer program indicated by offline memory device.

It should also be noted that the present invention can be implemented in a combination of software and/or hardware and is not limited to devices, which are physically connected and/or located within the same physical location. One or more of the devices illustrated in FIG. 1 can be located remotely and can be connected via a network. One or more of the devices can be connected wirelessly, such as by a radio-frequency link, either directly or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject the result, or may be assisted by data or metadata (data or metadata that may be user supplied, supplied by another computer program or database from a different application or determined by an algorithm). Moreover, the algorithm(s) may interface with a variety of workflow user interface schemes.

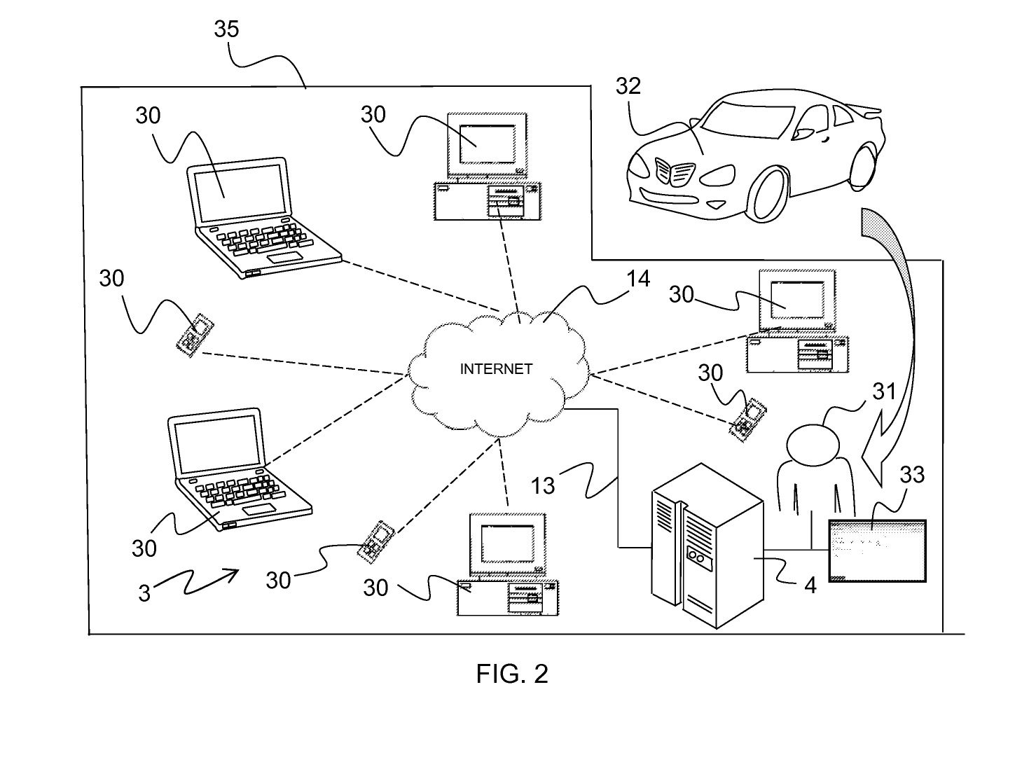

In the first embodiment as shown in FIGS. 1 and 2, the vehicle trade banking system, indicated diagrammatically as 35, would include the above described computer system 3, application software 17, one or more databases 19 including a quote history database 21 and storing data records 23 of vehicle information, member contact information database 25, status, and quotes. The system further includes a notification generator 28 that will be described in more detail below. Access to external data records and/or databases 27, for example access to additional vehicle information based on a vehicle identification number (VIN) or access to a vehicle value guide such as NADA Guide or Kelley Blue Book® for additional pricing information and possibly price quote comparison may also be provided. User logins and preferences would link specific user information to their user identification to provide predetermined access to information for each user. Administrative tools within the application software 17 would monitor, add or remove users, manage content and set restrictive/predetermined access to users of the vehicle trade banking system 35.

The vehicle trade banking system 35 embodied within the above described computer system 3 shown in FIGS. 1 and 2, is a valuable benefit for dealers and wholesalers as well as for the retail consumer looking to trade-in or sell a vehicle. By retail consumer is meant generally an individual, or for instance a small business entity, which is not in the business of selling new or used vehicles other than as a means of upgrading or obtaining a newer/different vehicle. By way of a general example, a consumer interested in purchasing a new or different vehicle, may own a vehicle that is not of a type normally sold by dealer, but wants to trade-in the used vehicle to obtain a discount or lower price on the desired new/different vehicle from this first dealer 31. The first dealer 31 who may also be referred to as the seller on the vehicle trade banking system 35, although he does not as of yet actually own the vehicle, may be hesitant to accept or take a trade-in if they do not have an offer, i.e. a quote, from another dealer or wholesaler where the first dealer can “bank” the trade-in. The first dealer 31 also needs to have an accurate quote from the wholesalers and/or other dealers, on the vehicle in order to determine a reasonable offer and negotiate with the consumer.

An important aspect of the present invention is to improve the efficiency of the dealer-to-dealer and dealer-to-wholesaler relationship (although other buyer-seller relationships can certainly be improved as well) that facilities the trade-in process. Through the computerized vehicle trade banking system 35 shown in FIG. 2, an efficient dealer network is developed, the network itself being represented by the different members 30 having computers, laptops, PDA's, iPods, iPad, tablets, cell phones, and other digital media communication devices, record(s) of the transaction data can be maintained through active database management handling transactional data. The transactional data includes but is not limited to vehicle information, condition, quote requests and quotes, and this data should be readily available to both the first dealer 31, and the wholesaler 30 and/or other dealers i.e. buyers or potential buyers in the system 35 that quoted the vehicle 32 so that hours, days, weeks or even months after the initial communications, the first dealer 31 can continue and consummate banking the trade. The databasing of such information is also important so that there is a readily available record of all the transaction data should the need occur to renegotiate the deal if the trade-in vehicle for example does not meet the quality description from the first dealer 31.

As shown in FIG. 2, and by way of a general example, a trade-in vehicle 32 is offered to a first dealer 31. The first dealer 31 does not want the trade-in vehicle 32 but wants to make a sale of for instance a new vehicle offering something to a customer for the trade-in. Through use of the below described system the first dealer 31, i.e. the seller on the system 35 can request a quote from the network of dealers 30 some of whom may want, need the trade-in vehicle 32. To request a quote from all or any specified network dealers/wholesalers, i.e. members 30, of the vehicle trade banking system 35, the first dealer 31 logs into his account, shown diagrammatically as a vehicle information input screen 33, on the vehicle trade banking system 35 and adds or posts for example, the make, model, year and condition of the offered trade-in vehicle 32 to the vehicle trade banking system 35, optionally uploading even picture(s) of the vehicle 32. The networked members 30 of the vehicle trade banking system 35 may receive a notification of the posting of a request for a quote. The notified members 30 may then quote on the vehicle 32 through the vehicle trade banking system 35 over the internet using any of the now known or future developed digital communications devices such as personal computer terminals, laptops, cellular phones, PDAs, iPods, iPads, and any other handheld mobile devices or appropriate equipment. A further description of the vehicle trade banking system 35 including the vehicle posting, databasing and quoting process is described in further detail below.

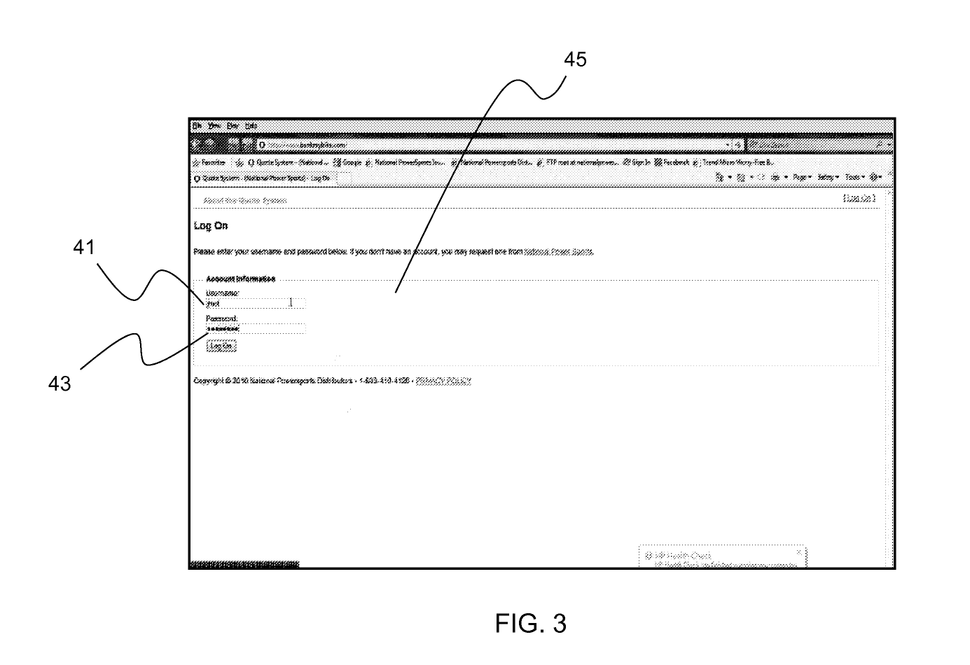

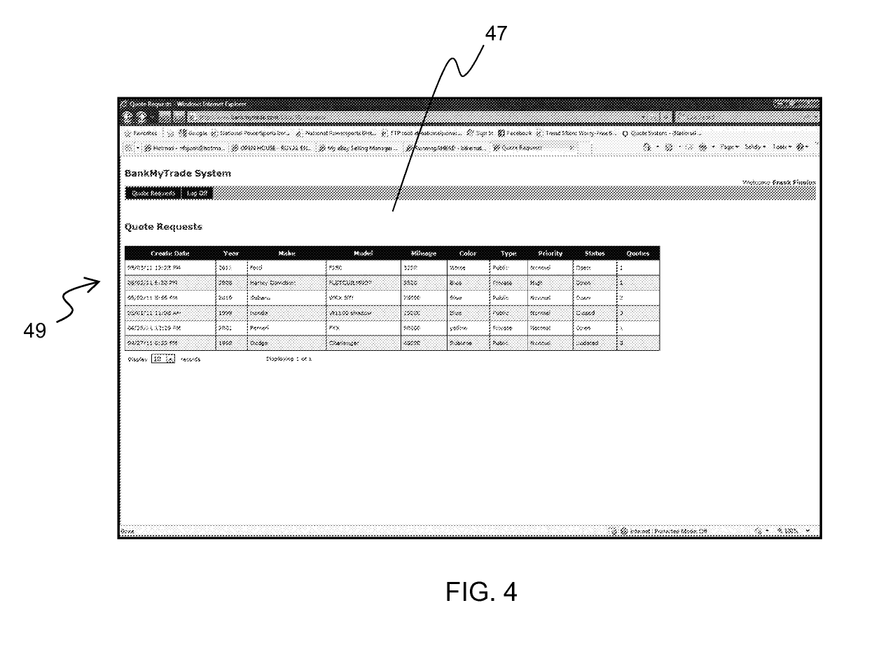

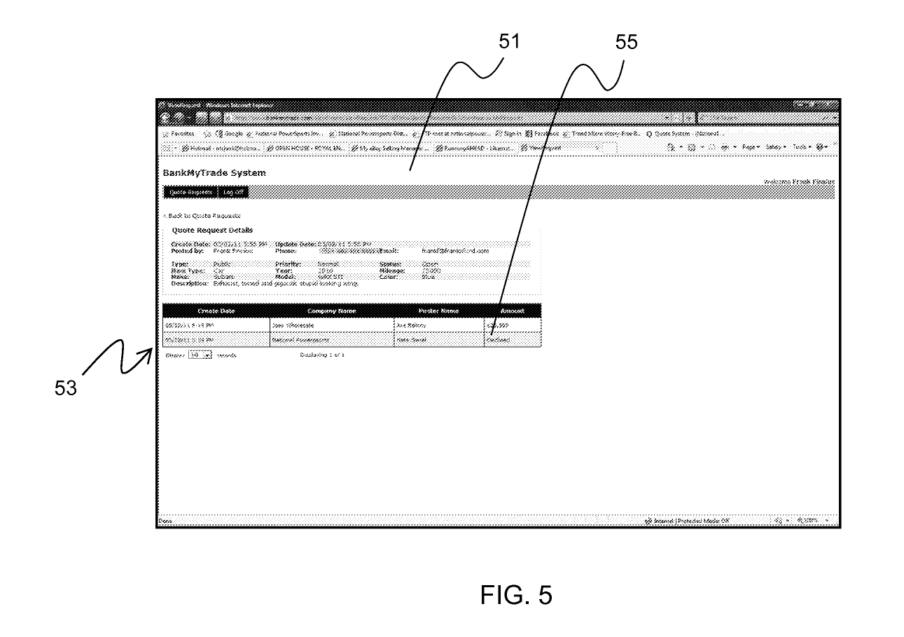

The installation of the vehicle trade banking system 35 on a server 4 connected to the internet 14 provides a platform for any number of members 30 to have access to the vehicle trade banking system 35. In general, to use the system at any time a member 30, (a member 30 may be a seller, buyer, or both a seller and a buyer, or a retail consumer requesting a one-time quotation for a vehicle) of the vehicle trade banking system 35 must enter a secure user name 41 and password 43 on a login screen 45 as shown in FIG. 3. From the standpoint of the first dealer 31, i.e. a seller, for example who has posted any number of potential trade-in vehicles to the system requesting quotes, after login to the system, the user interface may be defined and configured to display a quote request screen 47 as shown in FIG. 4 which tabulates or lists the individual currently open quote requests 49 which the first dealer 31 has previously submitted to the network members 30. The individual quote requests 49 on the quote request screen 47 each link to a vehicle specific quote page 51 shown in FIG. 5 which details a list of received quotes 53 or that a member 30 has indicated a declined quote 55 on a particular vehicle.

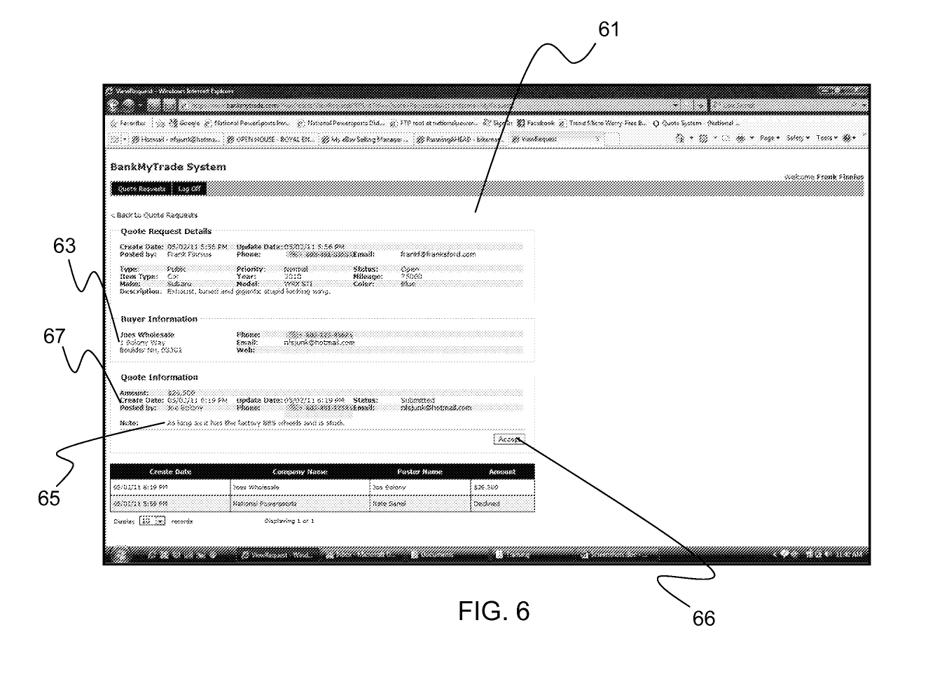

From the table of quotes on the vehicle specific quote page 51 the seller 31 can obtain and immediately compare the basic details of the potential buyers, e.g. create date, company/individual name(s) and quote amount, from whichever member 30 has quoted on the vehicle. The seller 31 can then, by selecting the buyer's specific quote from the vehicle specific quote page 51, open a Quote Request Details screen 61 shown in FIG. 6 which gives the seller the Buyer Information 63 including any comments or notes the potential buyer has set forth in the ‘Note:’ portion 65 of the Quote Information block 67. The seller may accept the quote by selecting the quote accept button 66 as described in further detail below.

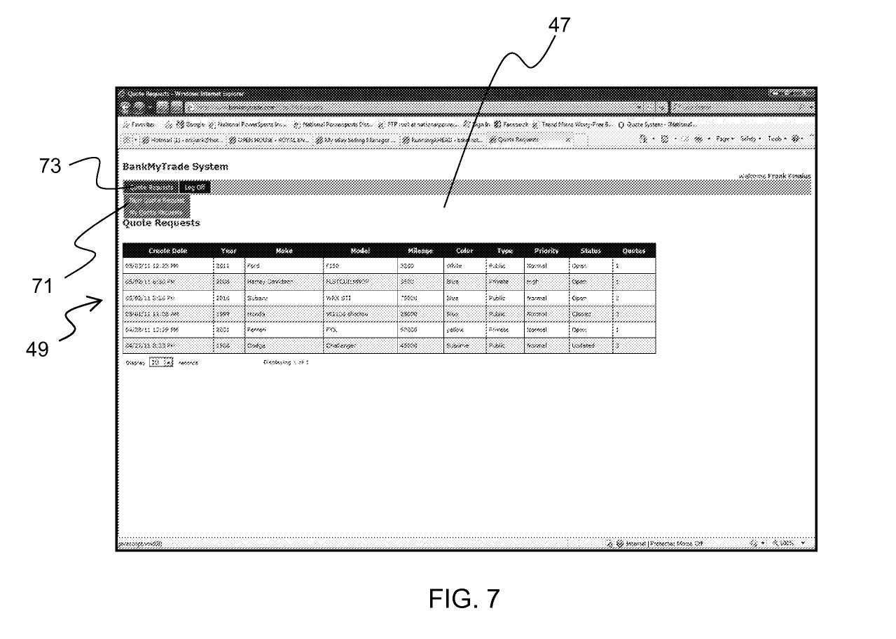

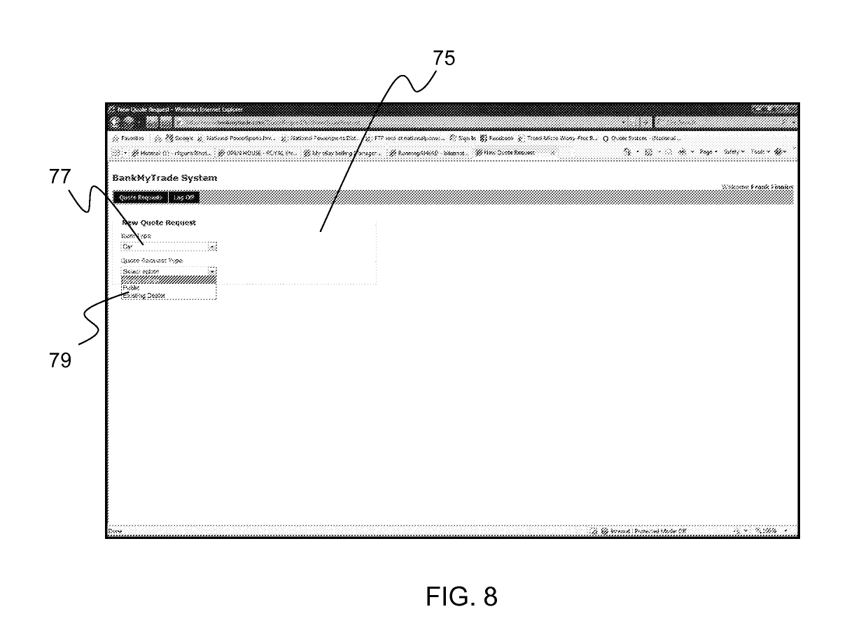

Continuing with the above scenario where the first dealer 31 wants to enter a new trade-in vehicle for a quote request from network members 30, as seen in FIG. 7, to submit the trade-in vehicle for member buyers 30 to quote on, the first dealer 31 selects New Quote Request 71 from a drop down Quote Requests menu 73 on the quote request screen 47. This brings up a New Quote Request page 75 shown in FIG. 8 including Item Type 77 for the type of vehicle; car, boat, motorcycle etc., and a Quote Request Type 79. The quote request type 79 may allow either an entire network or a specific predetermined subset i.e. a group, of the network members, or even a single member to be selected as the quote request recipient(s). This is an important choice as the first dealer 31 may want to focus the quote request on certain buyers 30 who may more readily provide a quote on the trade-in.

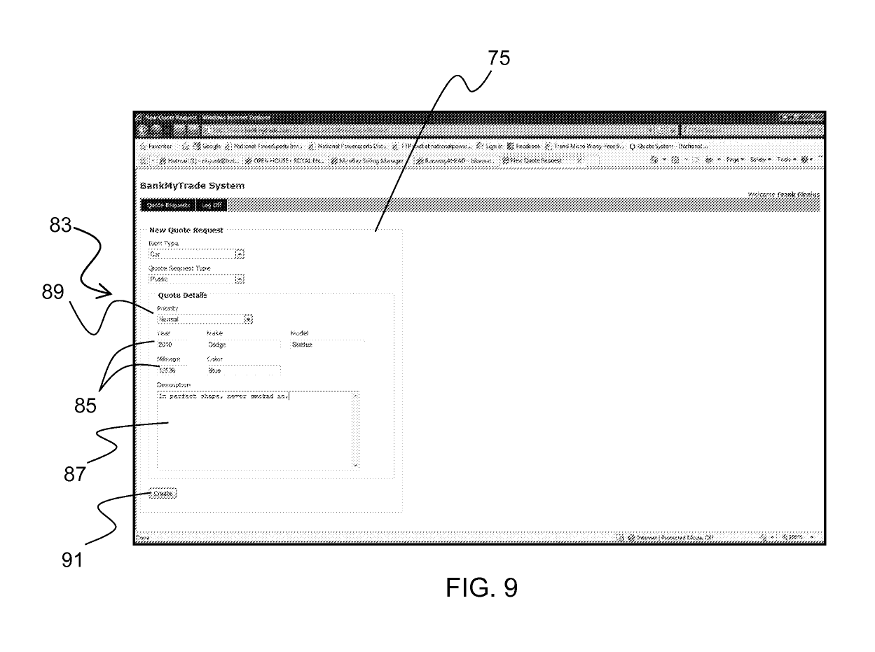

Subsequently to entering this information, the New Quote Request page 75 displays a vehicle entry form 83 or drop-down menu selections as shown for example in FIG. 9. The entry form 83 provides fill-in or selection boxes 85 for the first dealer 31 to enter the trade-in vehicle make, the year the vehicle was made, the model of the vehicle, the mileage of the vehicle and the color, etc. In the present embodiment, the vehicle trade banking system 35 also provides a description or comments box 87 to provide for a user to enter information about the condition of the vehicle, the location, and any other information or features of the vehicle that may assist a potential buyer in providing an accurate quote for the vehicle. In addition to comments and descriptions, one or more pictures of the vehicle may be inserted into the vehicle entry form.

An important feature of the vehicle entry form 83 is the priority setting field 89 that allows the first dealer 31 to indicate if a quotation for the vehicle must be provided immediately or if the need for a quotation is a normal, or low, or even high i.e. urgent, priority. The priority setting 89 allows a dealer for example who has a consumer with a trade-in vehicle on-site, to post the quote request while the user is on their lot waiting. By setting an urgent priority, the dealer 31 is telling the network members 30 that the dealer is in the middle of negotiations and a price quotation from an interested buyer is needed immediately. As soon as the new vehicle information is saved to the system 35, a notification, generally via email, with the priority 89 is sent to interested buyers 30 on the network providing for the seller 31 to receive quotations within a very short period of time as described in further detail below. A normal or low priority setting may indicate that there is an interested party with a trade-in, but that there are no current negotiations or alternatively that the dealer 31 may have already taken in the trade and now wants to find a buyer 30 for the vehicle.

Upon completion of the new vehicle entry form 83, the first dealer hits the Create button 91 and the form 83 is saved into the system database 19 triggering the notification generator 28. Next, the notification generator 28 extracts pertinent information from the saved data in the new vehicle entry form 83 and converts the information to one more electronic messages in one or more formats, for example email, tweet, text or other known or future known message formats, to accommodate different communication devices accessible to the internet 14. For example, the electronic message could be a tweet or text simply stating pertinent information that, “a new FORD® vehicle has been entered with a priority of urgent”. Alternatively, a more complete message may also be created including all or any portion of the entered information for the vehicle such as the make, year, model, mileage, color, condition and/or pictures. The converted electronic message is forwarded according to instruction from the application software 17 to the network of members 30 of the vehicle trade banking system 35. The flexibility of content in the electronic message from minimal content to more detailed information provides users of different electronic media such as cell phones receiving text messages to receive the simple notification of an added vehicle priority urgent, to more detailed messages to forward to email servers for users of personal computers, laptops, PDA, iPod, iPad or other handheld devices using wireless, Bluetooth or other technologies to receive communications.

The notification generator 28 determines the appropriate complexity of the message based on preference information provided by the members 30 to the application software 17 at initial account setup. The notification generator 28 includes a decision making engine 29 which associates specific members 30 desired notification requirements, e.g. text, tweet or email, with the appropriate data from the trade-in Quote Details entry form 83 and distributes the appropriate electronic message notification to the member.

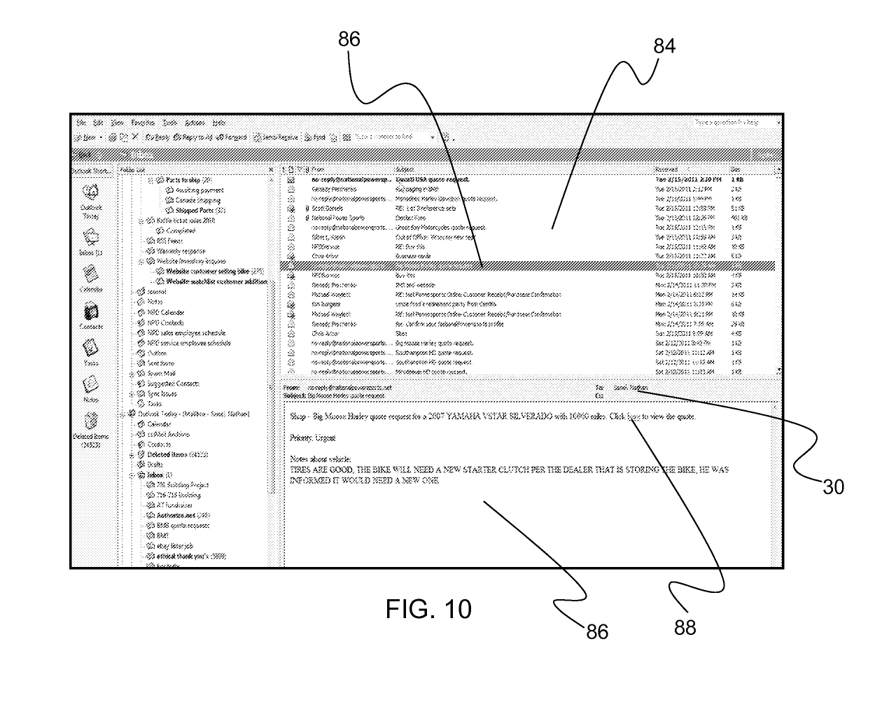

The electronic notification messages are for example distributed according to the member's predetermined requirements to a member's email system 84 and/or to a user's cell phone as a text message. The notification message 40 of the addition of a new vehicle with the priority setting is distributed to all members 30 or to a select group of members 30 based on member preference setting requirements that allow a member to receive notifications for only specific vehicle makes, models, and year ranges. Using the preference settings, the newly added vehicle is targeted to specific members 30, i.e. buyers interested in purchasing a vehicle of for instance a specific make and model. The notification message 40 can be essentially an alert to the member 30 that a vehicle of interest has been posted by another member (seller) for quotes. The message 40 shown as email 86 sent by the notification generator 28 to a member buyer 30 in FIG. 10 cannot only alert the member to a new quote request but also include an access link 88 for the interested buyer to select to open the member's account in the vehicle banking system 35.

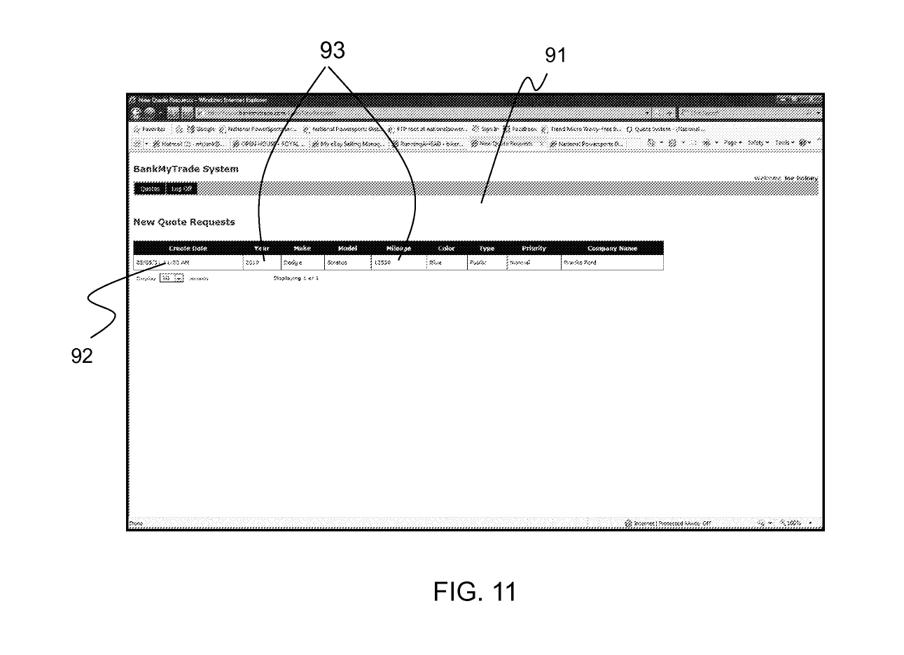

Turning now to the member buyer 30 who is receiving the quote request message 40, assuming the member buyer 30 clicks on the access link 88 to open their account in the system 35 the member 30 is presented with their member login screen 45 as previously shown in FIG. 3, enabling the member 30 to login to their individual account on the vehicle trade banking system 35. The member 30 enters their secure member name 41 and password 43 to access the account similar to that as described above with respect to the first dealer 31. In the case of a buyer 30 however, the initial buyer's page 91 shown at FIG. 11 provides information to the member buyer about the specific vehicle in the most recent notification message 40, and/or all newly entered vehicles 92 in a tabular format. The tabular data includes the column formats 93 including by way of example but not limited to: create date the vehicle was added, the make, model and year of the trade-in vehicle, vehicle mileage and color may be listed along with other data which is readily available to the system, for example, the first dealer 31 offering the vehicle and the priority can also be listed.

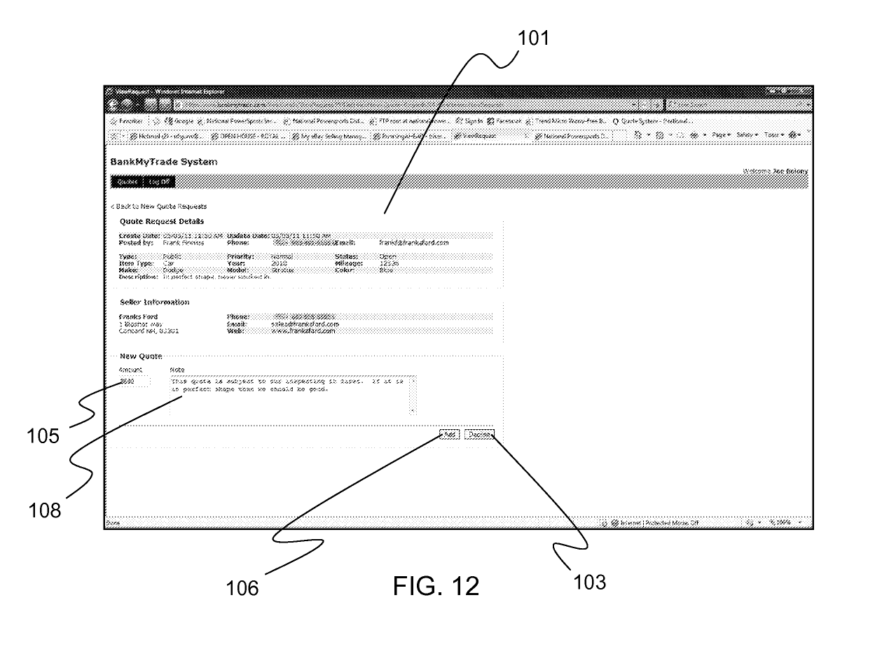

The member buyer 30 can select the individual quote from the tabular format of the newly entered vehicle 92 and a Quote Request Details page 101, providing details of the quote request is provided as shown in FIG. 12. The member 30 can decline the request by clicking the Decline button 103, or after filling out the appropriate amount at 105 the member wishes to quote for the trade-in vehicle, the member 30 can select the Add button 106 to add this quote to the system 35. The quote entry screen 101 as shown in FIG. 12 and similar to the vehicle entry form 83 includes a comment field 108 that allows the buyer 30 to make comments, raise concerns, or request more details about the trade-in vehicle.

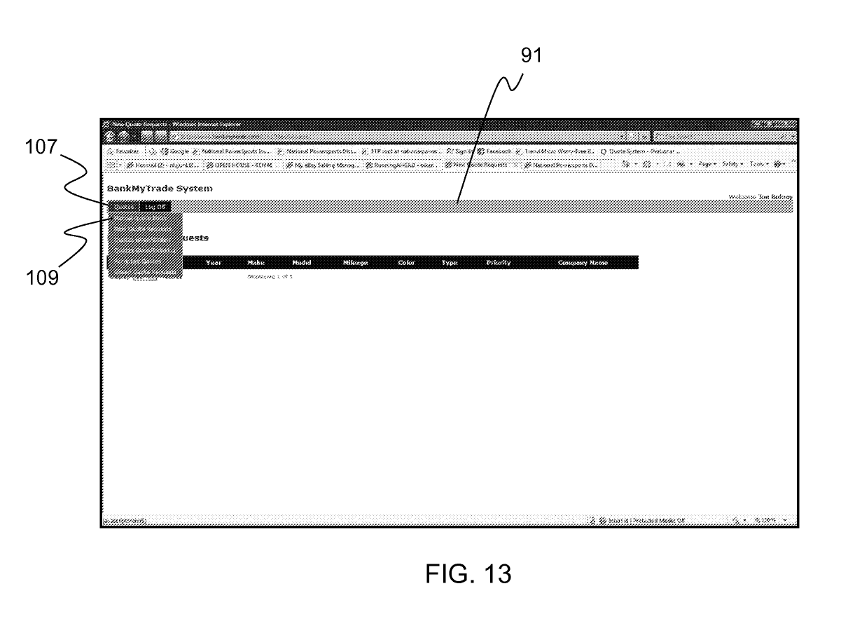

Turning to FIG. 13 the member buyer's main menu includes a Quotes button 107 that has a drop-down menu having a series of selections including a Manual Quotes selection 109. Manual quotes allow for anyone to enter a quote for someone else. For example if a member buyer 30 cannot, or does not want to login to their own account system 35 for say an urgent notification message 40, but instead telephones the first dealer 31 directly, the first dealer 31 can enter the quote through their own account from the phone conversation for the member buyer 30.

The further selections under the Quotes button 107 may include New Quote Requests, i.e. outstanding quotes requests that the member 30 has not responded or declined yet; or completed but unaccepted quotes directed to specific groups such as quotes to other dealers, quotes to individual consumers, etc; or accepted quotes, important because the member can see which quotes have been accepted and can follow-up with seller to arrange for receiving the trade-in vehicle. Another screen or selection can facilitate consummation of the sale indicating for example to the buyer when the trade-in vehicle is ready to be picked up from the seller. Closed quote requests may also be available on the Quote button menu 107, providing a recorded history of quotes given and possibly purchased vehicles.

It is to be appreciated that a member 30 may also be both a member seller, and a member buyer. In such a case, upon logging into their account both initial buyer and seller screens may be presented to the member 30, alternatively a menu providing for selection of either the buyer or the seller's role may be presented to the member and direct them to the appropriate initial page.

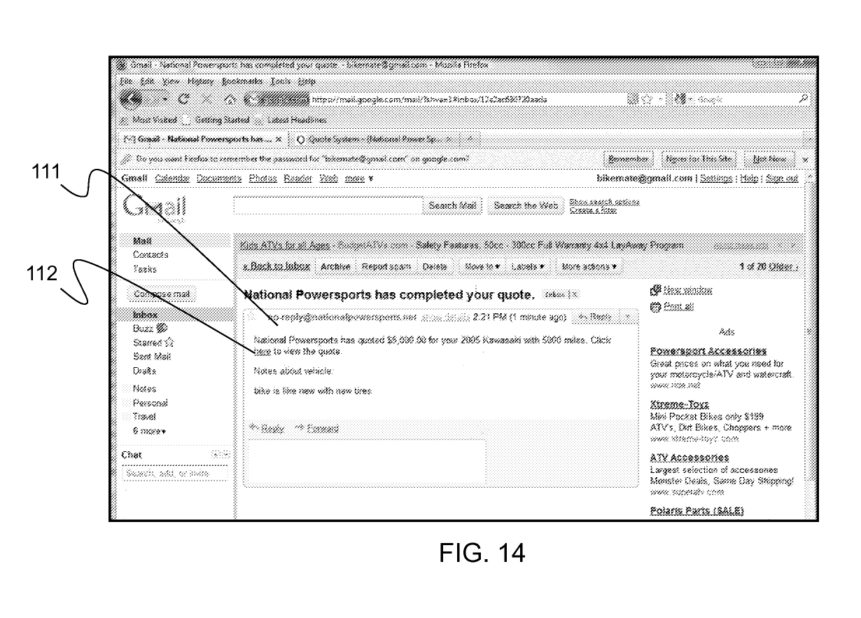

In the presently described embodiment, once the member buyer 30 has posted added, entered etc., the quote via the Add quote button 106, the application software 17 using the notification generator 28 immediately extracts predetermined quote information, for example the quoted price information at 105 and the identity of the member buyer 30 and creates a responding electronic message of one kind or another, such as an email, tweet or text message 111 as shown for instance at FIG. 14, to send back to the first dealer 31. The simplification of message information using the notification generator 28 to select a subset of data from the buyer's quote, is critical because it allows for an email, text or tweet to be sent efficiently with minimal transmission and download time providing only the necessary information to the dealer 31 that is needed to determine how, or if to follow up on the received quote with the buyer 30, or if the quote is helpful in on-going negotiations with the consumer. For example, the first dealer 31 having received a favorable quote, i.e. offer for purchase of the trade-in vehicle, now has a price to use to determine a trade-in value to the consumer.

Similar to the notification message 40 generated to the network members 30 initially, in the buyer generated email of FIG. 14, an access link 112 is provided for the first dealer 31 to login in to the vehicle trade banking system 35 to review further details of the quote which are now stored and maintained in the database 19 and if appropriate accept the quote.

The first dealer's vehicle specific quote page 51 previously shown in FIG. 5 is where the member buyer's new quote is listed. As previously described, from the table of quotes on the vehicle specific quote page 51 the seller 31 can obtain and immediately compare the basic details of the new quote with other potential buyers, e.g. create date, company/individual name(s) and quote amount, from all members 30 who have quoted on the trade-in vehicle. The seller 31 can then, by selecting the buyer's specific quote from the vehicle specific quote page 51, open a Quote Request Details screen 61 shown in FIG. 6 which gives the seller the Buyer Information 63 including any comments or notes the potential buyer 30 has set forth in the ‘Note:’ portion 65 of Quote Information block 67.

If more than one quote has been offered for the new vehicle 32, the seller 31 may use the vehicle specific quote page 51 to compare quotations and determine the most appropriate price offer for the trade-in vehicle 32. To accept any quote, the seller 31 selects the desired quote to be accepted, and through the Quote Request Details screen 61 selects the Accept button 66 as shown in FIG. 6.

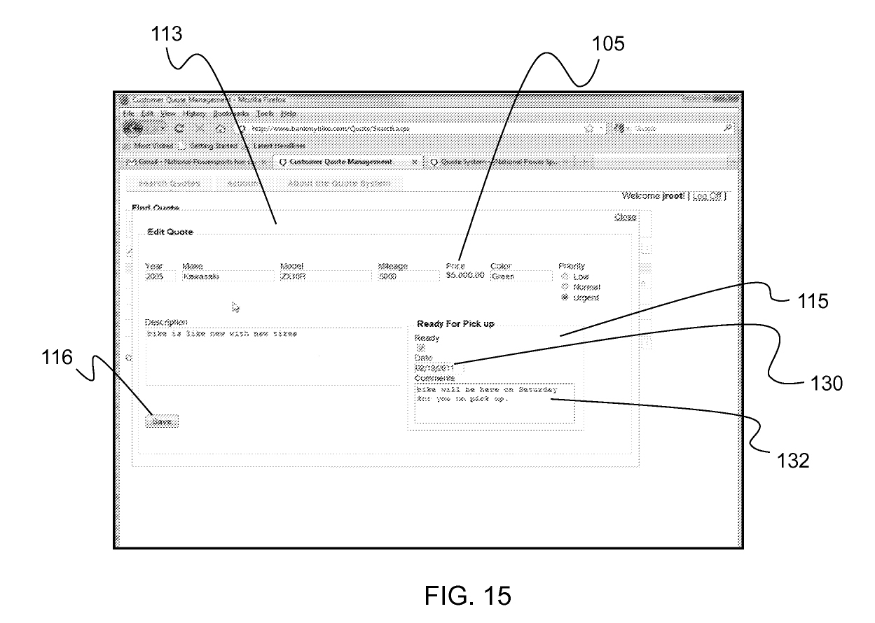

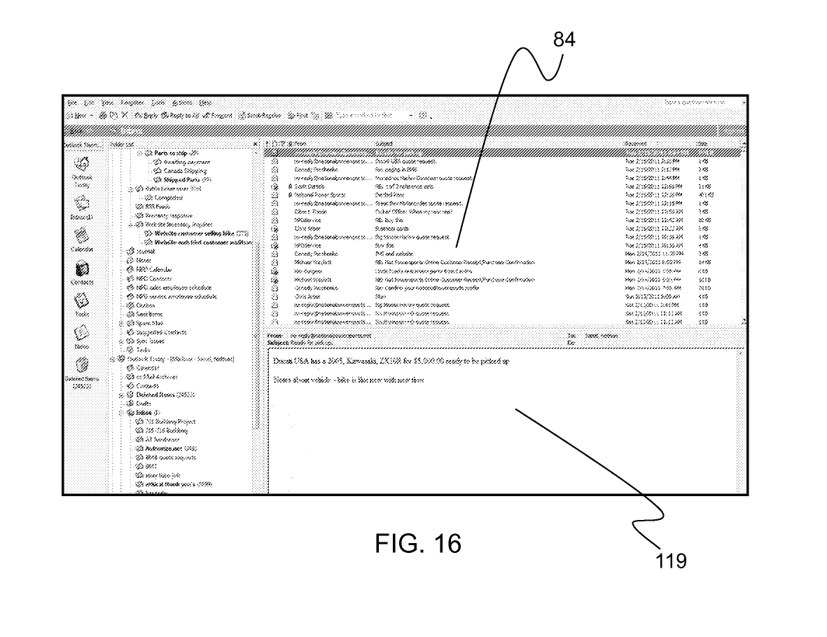

By selecting the Accept button 66, the first dealer 31 or seller has selected and accepted a desired quote. With such acceptance, there may also be provisions on a Quote Acceptance screen 113 as shown in FIG. 15 such as a Ready For Pick up window 115 for input of a date 130, and a comment box 132 where a pickup time and location of the vehicle and other additional information may be entered. After selecting the save button 116 accepting the quote, the application software 17 triggers the notification generator 28 to create a quote acceptance message 119 as shown in FIG. 16 which could be an email, tweet, or text message as described above to notify the member buyer 30 that the first dealer 31 has accepted their quote. Again, such a quote acceptance message 119, generally referred to as a notification message 40, can be configured through the decision making engine 29 to include only part of the acceptance and transactional data and information stored in the database 19 in the quote acceptance message 119.

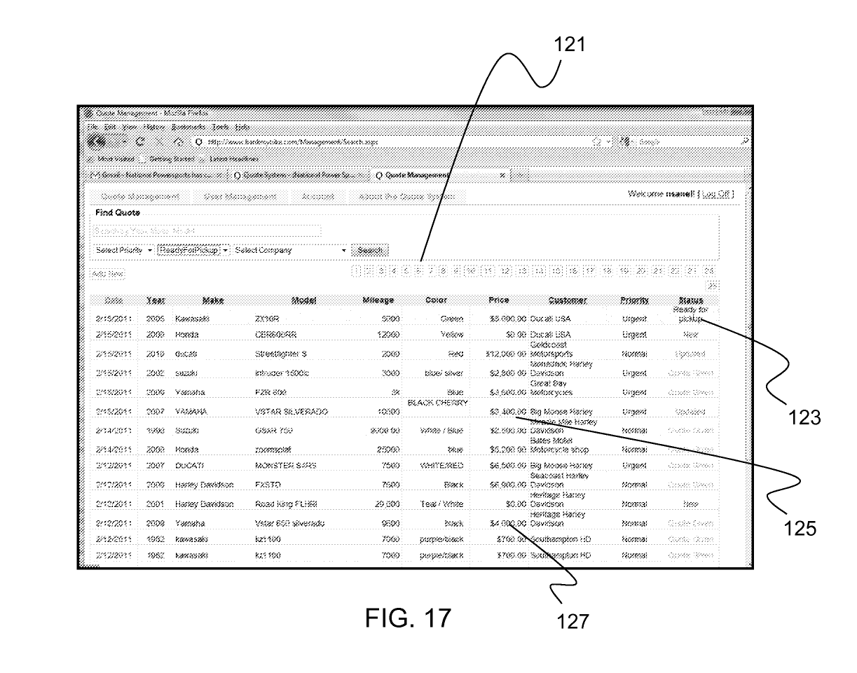

Upon receipt of the quote acceptance message 119 the buyer 30 may login into the vehicle trade banking system 35 to obtain any further updates or the status of the planned vehicle purchase from the first dealer 31. The seller 31 in this regard may have an additional vehicle quote management screen 121 providing available options for status entry as shown in FIG. 17. The status 123 of the trade-in vehicle is updated to “ready for pickup”.

A vehicle quote management screen 121 is an important feature of the vehicle trade banking system 35. The screen 121 provides vehicle information for every vehicle of interest posted by any dealer with a price offered for each quote and a current status 123 of the vehicle purchase transaction. The table format allows the member to quickly review a number of pending transactions and determine if a quote is accepted, a vehicle is ready to be picked up or the vehicle has been picked up. A review of the offered and accepted quotes with the particular vehicle make and model also provides a good general estimate to determine future price quotations for vehicles of similar make, model and condition. For example, a review of the vehicle entries could quickly provide an estimate that a newer Yamaha Silverado with low mileage should be quoted at a value of between $3400 and $4000 as the two entries for a 2007 Silverado 125 and a 2009 Silverado 127 indicate in FIG. 17. Price quotations are always time and location sensitive, so this recent information combined with a review of a NADA Guide or Kelley Blue Book® may provide a very accurate quote that maximizes the profit in reselling the vehicle.

Information from vehicle quote management screen 121 may also be extracted and analyzed to determine a live snap shot of the most recent price quotation values for specific vehicles, or availability of a specific, make or model which is more up to date and geographically specific for the system members. The data for analysis may be from stored data of a single member or group of members or using software administrative tools and permissions, a global analysis of all system data may be performed. The extracted values and compilations of data could be exported and/or compared with other available external database value guides such as NADA Guide or Kelley Blue Book®, for additional price information to assist in producing accurate quote estimates in real time for any vehicle within the vehicle trade banking system.

Additional access screens and login permissions, within the application software may provide members with access to specific algorithms to perform localized analysis of vehicle quotation data within their system account to allow them to obtain up to the minute vehicle pricing. Further permissions and access tools within the application software may allow a user to enter a specific vehicle make, model and year and obtain a quotation based upon a global analysis of all stored data within the vehicle trade banking system database, providing a more up to date and accurate value based on actual offered and/or accepted quotations and sales of vehicles within their geographic area than may be obtained using an online vehicle value guide.

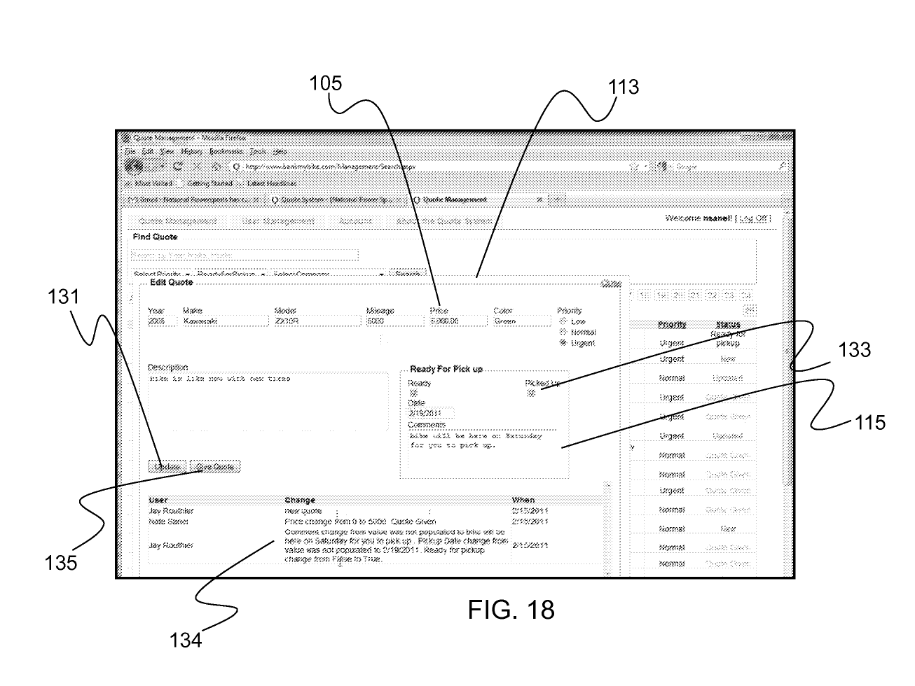

Turning to FIG. 18, the member 30 or an associate of the member who is picking up the vehicle may select the vehicle from the list on the quote management screen 121 and open the quote entry screen 113. The member 30 may review the pickup time and suggest a change by entering a new time in the pickup comments window 115 and selecting the update button 131. The comments screen 115 also provides the condition of the vehicle that was initially entered by the seller. The member picking up the vehicle may review this information and inspect the condition of the vehicle at the time of pickup. If there are no issues with the condition of the vehicle then the picked up tab 133 may be selected and a notification 40 is sent to the seller 31 notifying the first dealer 31 the vehicle 32 has been picked up and the transaction is completed. An audit trail 134 may also be provided which displays each communication in the transaction between the seller 31 and buyer 30.

Any damage to the vehicle or any issues may be recorded in the comment box and saved by selecting the update button 131. The member buyer 30 may also enter a new price quotation 105 to match the actual condition of the vehicle 32 and select the give quote button 135. The application software 17 initiates the notification generator 28 and an email and/or text message as described above with the updated quotation 105 is sent to the seller 31. The seller 31 logs in to the vehicle trade banking system 35 to review the comments and decide whether to accept the new quotation 105. If accepted the buyer 30 receives a notification 40 of acceptance and the vehicle 32 may be picked up for the new price without any additional telephone contact or negotiation saving time for both the seller and buyer. For example the initial offer of $5000 may be reduced to $4500 when a dent is discovered in the vehicle 32.

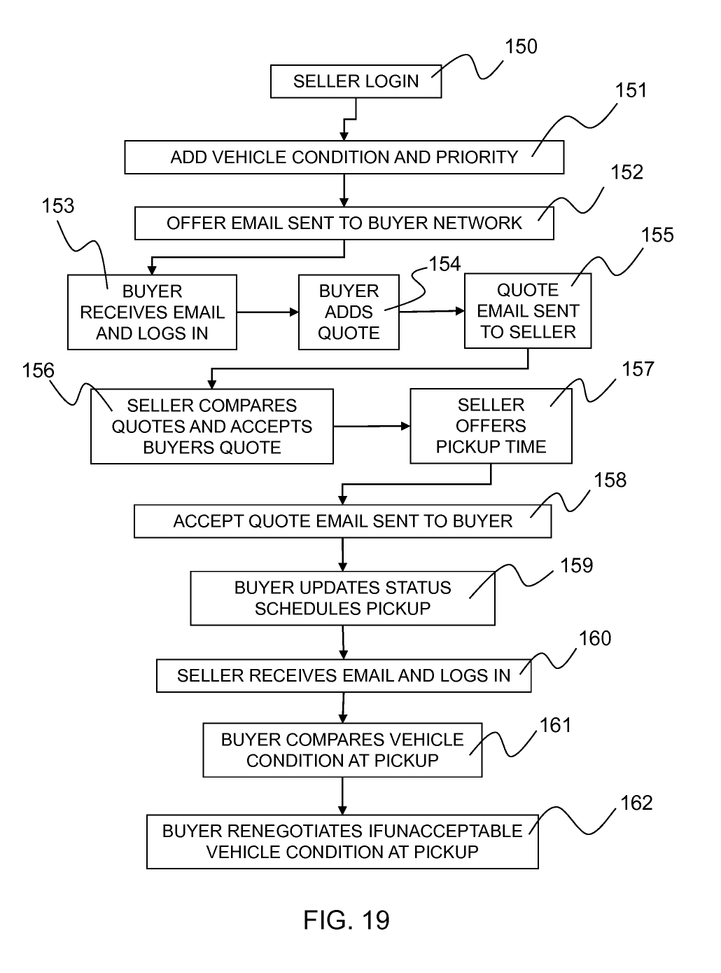

A flow diagram of the general system process algorithm in a first embodiment of the vehicle trade banking system 35 is shown in FIG. 19. As an example of a method of operation for the vehicle trade banking system 35, the seller logs in 150 and adds a new vehicle and a priority 151. An email is distributed to the interested buyer network 152. An interested buyer receives the email, logs in 153 and enters a price quotation for the new vehicle 154. The buyer entered quotation is emailed to the seller 155. The seller reviews the quotations and accepts an appropriate quotation from a buyer 156. The seller offers a pickup time 157 and an email is sent to the buyer 158. The buyer updates the status of the vehicle and schedules the pickup 159. The seller receives a confirmation email of the scheduled pickup 160. The buyer compares the condition of the vehicle at pickup to the condition entered by the seller 161. The buyer renegotiates the price if the vehicle does not meet the condition entered by the seller 162. The renegotiation may be straight forward for both parties where the audit trail 134 records all communications of the purchase transaction and all information on condition of the vehicle from the seller and the price offered by the buyer is easily accessible within the quote entry screen, allowing each party to negotiate in good faith based on the available transaction information.

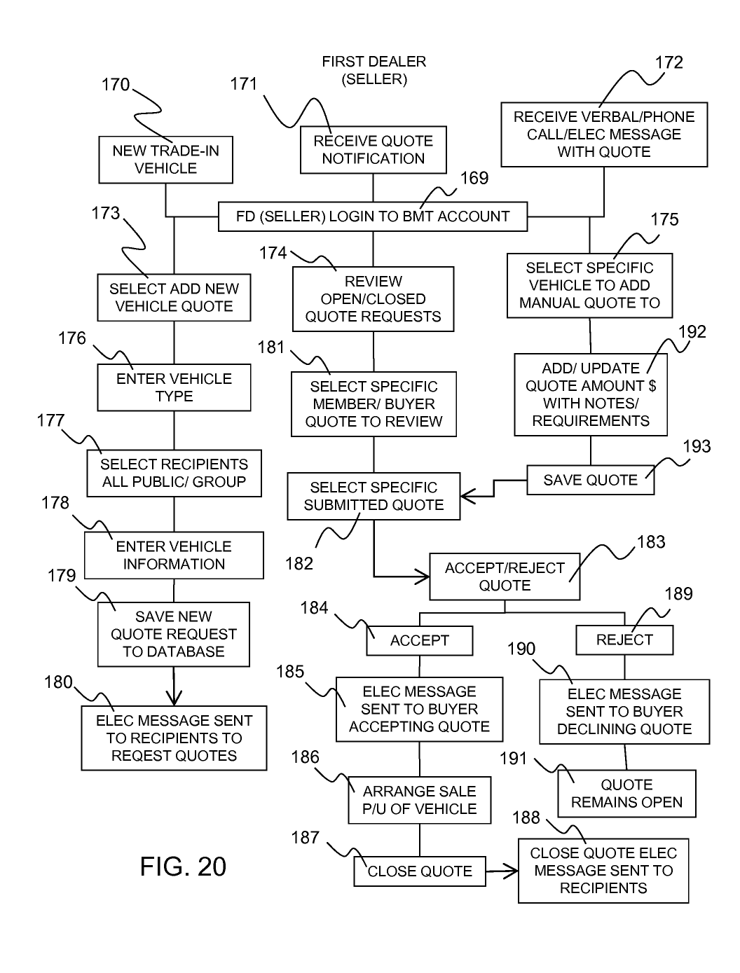

The more specific Member/First Dealer (seller) system algorithm is shown by the diagram in FIG. 20 where the seller has either a new trade-in vehicle at step 170 to enter into the system or alternatively receives an electronic notification of a quote 171 or receives a request to enter a new quote manually at step 172 verbally from an interested buyer and the quote must be entered on a previously requested quote. Based on this, the first dealer logs into Bank-My-Trade account 169 and has essentially three (3) initial options, enter a new vehicle at step 173, review and compare quotes at step 174 or enter a new vehicle or quotation that was electronically or verbally given to the seller manually at step 175.

As an example, where the first dealer desires to add a new trade-in vehicle and request quotes thereon, following logging in procedures the first dealer selects at step 173 for instance in a drop-down menu to add a new vehicle quote. Subsequently the vehicle type is entered at step 176 and the recipients of the new vehicle quote are selected at step 177. The recipients can be the entire member network or a select group or individual of the member network. The vehicle information such as, make, model year, mileage, and condition can be entered at step 178, although it is to be appreciated that the vehicle information step could also occur at a different location in the algorithm flow as well. The vehicle information as well as recipient information is saved to the database at step 179 and an automatic electronic message is sent to the recipient(s) at step 180. While notification to the entire member network may be selected for the recipients, the electronic message may be sent only to those members having a preference for the type of vehicle that is added as described above.

Where the first dealer has received a notification of a new quote on a certain vehicle, for instance via email, tweet or text, after logging in the dealer reviews the open/closed quote requests at step 181 and selects the specific open vehicle quote request to which the received notification relates at step 182. The first dealer can then review the details of the potential buyers quote and either accept or reject the quote at steps 183. If the quote is accepted 184 the system automatically sends notification to the buyer at step 185. The buyer and seller can consummate the sale and pick-up of the vehicle at step 186. The quote request may then be closed at step 187 and a notification that the quote request is closed may be sent to other buyers who provided quotes via text, email or other electronic means at step 188. The quote does not have to be rejected, but if the quote is rejected at step 189, an electronic message may be sent to the buyer declining the quote at step 190 and the quote request remains open 191. If the quote remains open, the potential buyer may have an opportunity to update and enter a new quote as described below.

A manual quote is understood as a quote entered by the first dealer 31 based on for example a telephone call or means of communication other than through the system 35, from another network member or anyone for that matter who wanted to quote on the trade-in vehicle. Often a member-buyer 30 may want to speak directly to the first dealer 31 and will offer a quote over the phone which is a conventional method. In this case the first dealer 31 can add the quote manually at step 172 after logging-in at step 169 to the first dealer's account and selecting the trade-in vehicle at step 175. The first dealer 31 may then enter the quote and any requirements essentially as a straw-man for the member-buyer 30 at step 192. This manual quote is then saved into the system's database 19 at step 193 as if it came from the member-buyer 30, and may eventually be accepted or rejected by the first dealer 31 as described in the previous steps as appropriate.

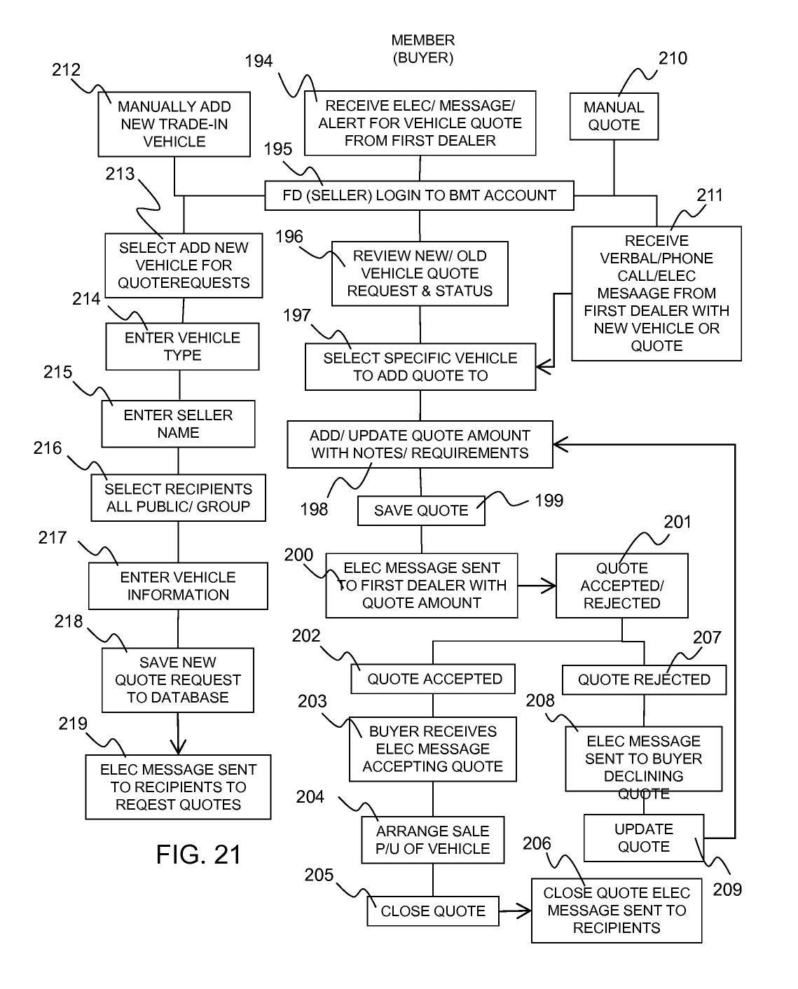

In the case of the member buyer 30 as set forth in FIG. 21, the member buyer receives an electronic message or notification of one kind or another such as an email, text or tweet at step 194 which notifies the member of a vehicle for which a seller is requesting a quote. One option is for the member to telephone or speak directly to the seller depending upon their business relationship, and give them a verbal quote. In this case the manual quote portion of the system is invoked where the seller may enter the quote for the member as described above. The other option for the buyer is to login to the member-buyer's Bank-My-Trade account at step 195 to review the new/old quote requests generally listed in the home menu. In the list of new/old quote requests 196, the member sees the new quote request corresponding to the latest electronic notification received and can select the new quote for more details of the vehicle 197.

In the quote request details page the member at step 198 can enter, or update, an amount of money the member is willing to quote on the vehicle as well as any requirement for conditions of the quote. At step 199 the quote is saved to the database 19 and a notification message 40 of the quote is forwarded automatically by the system 35 to the first dealer at step 200. The quote may be reviewed by the seller at step 201 and be accepted or rejected. If the member's quote is accepted at step 202, the member 30 will receive an automatic notification at step 203 via the desired electronic means through the system 35, and the member-buyer and seller can then coordinate the final sale and pick-up of the vehicle at step 204 using for example the Ready for Pick up Window 115 as described above. The quote request may be closed at step 205 and a notification of the closure of the quote may be sent to others buyers that submitted quotes at step 206. Alternatively, the quote may be rejected 207 and the buyer may receive a notification that the offered quote from the buyer was declined by the seller at step 208. However, the seller 31 may not close the quote request and therefore the member-buyer 30 may alter the quote at step 209. Another alternative is the quote is rejected because the seller 31 has selected a quote from another member and the member-buyer will merely receive notice that the quote request is closed.

As noted above, the member-buyer 30 may enter a manual quote 210 from a telephone call or an electronic communication with the seller at step 211. The member selects the specific vehicle at step 197 and proceeds as described above. The member may also manually enter a vehicle at step 212 from a communication with the seller. The member-buyer would login in to the member-buyer's Bank-My-Trade account 195 and select add the new vehicle quote at step 213, add the vehicle type 214, enter or select the seller's name from a list of members 215 and select the recipients 216. The recipients may be a public notification to the network or to a specific group or may be to only the seller if the sale had been previously agreed upon and the Bank-My-Trade system is used to store the transaction in the database. The vehicle information is entered 217, the quote request is saved to the database 218 and an electronic message is sent to the recipients requesting quotes at step 219.

A member 30 of the dealer network may also, depending on the member's subscription, have access at any given time to both buyer and seller system applications. In other words some members may only be sellers, some may only be buyers and some members 30 may be both buyers and sellers of trade-in vehicles and have dual access to the system applications. The vehicles do not necessarily have to be trade-in vehicles, conceivably vehicles put into the system could include new vehicles including boats, cars, trucks, motorcycles etc. Also, there is the capability in the system for a retail seller, i.e. any individual who is generally not a dealer or a wholesaler or even generally a member of the network, but who wants an immediate accurate quote on their vehicle from network members, to become a limited access member for example for a single vehicle posting, or for a period of time. A one-time fee or a percentage of the accepted quote for example could be charged to allow a retail seller to become such a limited access member in certain embodiments.

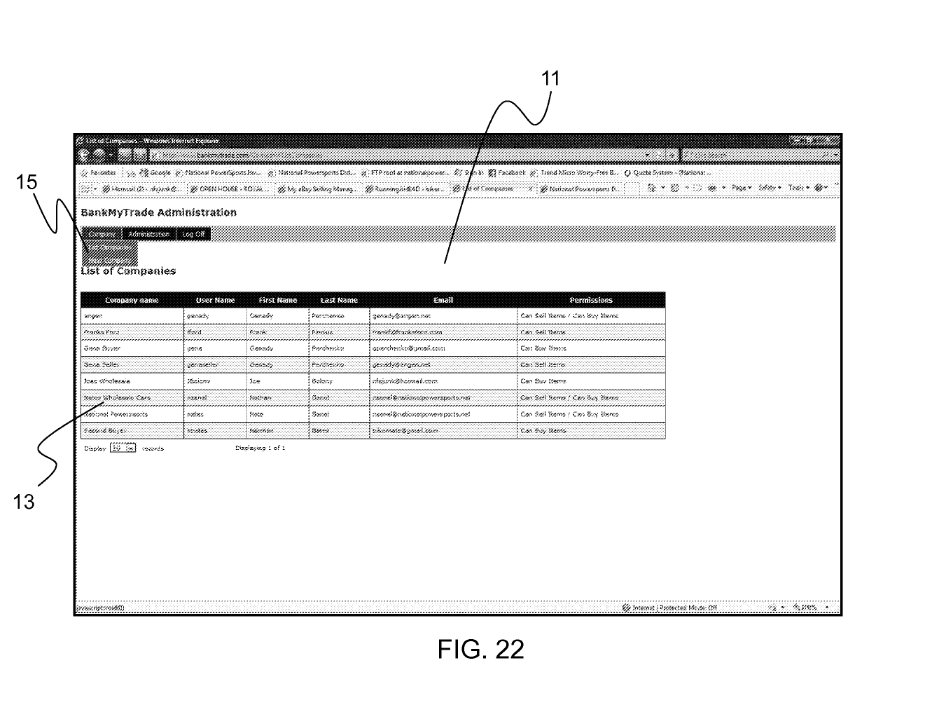

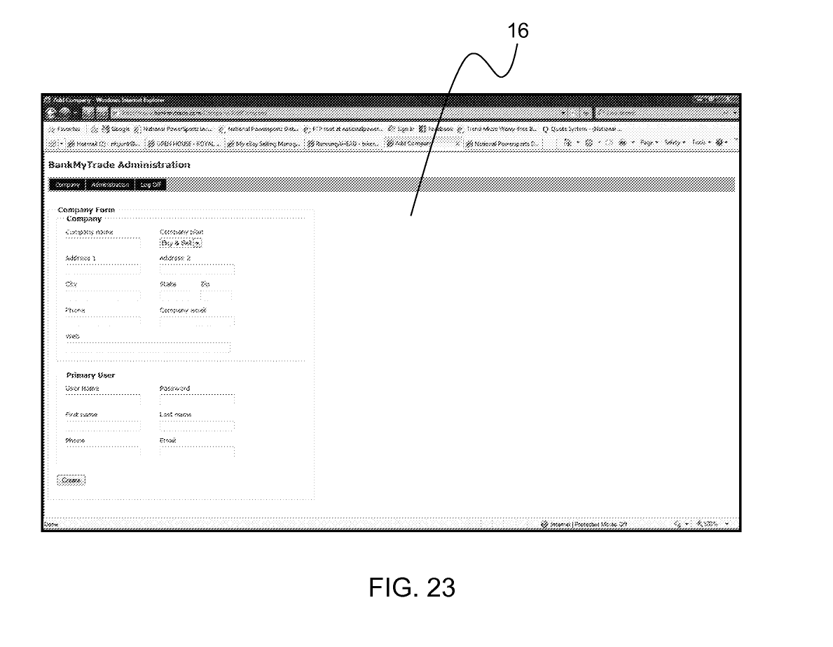

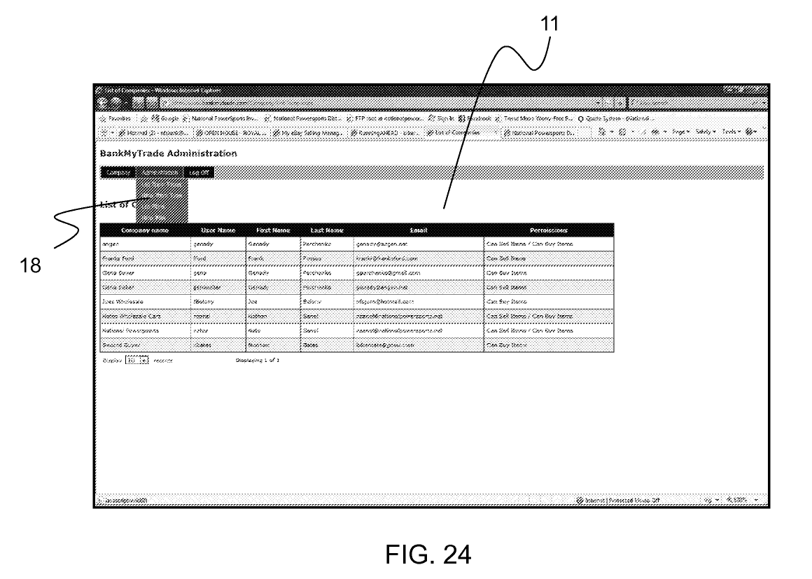

An administrative application of the system 35 can include administrative restricted account access 11 as shown in FIG. 22 which includes consolidated listing of the network members 13, their pertinent information and application permissions/rights. The administration rights may also include a selection menu 15 which permits the addition of a new member and changing/amending application rights to which each member is entitled based on a subscription for example. The administrative application can include an entry form 16 for new a member's information as shown in FIG. 23. Besides general information regarding each member 30, additional features of the administrative application include defining the types of quotes based on predetermined criteria which a member can receive, for example only a specific make i.e. Ford®, vehicles, or other criteria such as only 2009-current vehicles may be associated with particular members, and so act as a filter so the member gets only the vehicle information that the member wants to quote on generally. A drop-down menu 18 for example as shown in FIG. 24 can permit the adding and listing of vehicle item types to define the entry form 16, or adding and viewing plan types and subscription types as well as additional descriptions for filtering the quote requests to the members.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A vehicle trade banking system comprising:
application software installed on a server having a database and connected to the internet,
the application software comprising;
a new vehicle entry member interface;
a quote entry member interface;
a vehicle quote management member interface;
a quote history database having vehicle data and transaction information;
a notification generator; and
wherein the notification generator creates and transmits vehicle entry and quote entry transaction information using the internet to a network of interested vehicle buyers and sellers.

2. The vehicle trade banking system of claim 1 wherein the application software further comprises a status entry to communicate transaction status information for each vehicle entry.

3. The vehicle trade banking system of claim 1 wherein the application software further comprises a comment member interface.

4. The vehicle trade banking system of claim 1 wherein the application software further comprises a login member interface requiring a secure login identification name and password.

5. The vehicle trade banking system of claim 1 wherein the application software further comprises member preference settings to restrict vehicle transaction information not matching the member preference criteria.

6. The vehicle trade banking system of claim 1 wherein the application software further comprises an audit trail.

7. The vehicle trade banking system of claim 1 wherein the notification generator extracts transaction information and converts the information to acceptable formats for email and text messages.

8. The vehicle trade banking system of claim 1 wherein all transactions and communications of the network of vehicle buyers and vehicle sellers is stored on a secure database.

9. The vehicle trade banking system of claim 8 wherein the quote history database provides restrictive access to information based on each member's identification.

10. The vehicle trade banking system of claim 8 wherein vehicle data and quote transaction information may be analyzed and exported from the quote history database.

11. The vehicle trade banking system of claim 1 wherein the vehicle information includes one of at least make, model, year, mileage, color and condition.

12. A method of banking a price for a trade-in vehicle, comprising the steps of:
accessing a vehicle trade banking application software system;
entering vehicle information for a trade-in vehicle;
generating an electronic message from the vehicle information and distributing that message to a network of interested buyers;
receiving at least one electronic message of a price quotation from an interested buyer from the network of interested buyers;
accepting the price quotation; and
storing all information from the transaction on a database connected to a server that is connected to the internet.

13. The method of banking a price for a trade-in vehicle of claim 12 further comprising the steps of entering a status field for the trade-in vehicle.

14. The method of banking a price for a trade-in vehicle of claim 12 further comprising the steps of entering member preference data restricting distributed vehicle information to buyers having member preference data matching the vehicle information criteria.

15. The method of banking a price for a trade-in vehicle of claim 12 further comprising the steps of entering comments on vehicle condition.

16. The method of banking a price for a trade-in vehicle of claim 12 further comprising the steps of generating an audit trail of all information and communications of a transaction.

17. The method of banking a price for a trade-in vehicle of claim 12 further comprising the steps of generating an electronic message in suitable formats for any communication device connected to the internet.

18. The method of banking a price for a trade-in vehicle of claim 12 further comprising the steps of entering vehicle information including one of at least make, model, year, mileage, color and condition.

19. The method of banking a price for a trade-in vehicle of claim 12 further comprising the steps of mining data from the database for value comparison analysis.

20. The method of banking a price for a trade-in vehicle of claim 19 further comprising the steps of exporting and comparing mined data from the database with an external database.
